(19) United States
(12) Patent Application Publication
(10) Pub. No.: US 2007/0180076 A1
(43) Pub. Date: Aug. 2, 2007

(54) Usability by offering the possibility for usage analysis for UI elements

(76) Inventors: Udo Klein, Maximiliansau (DE); Michael Danninger, Landau (DE)

Correspondence Address: PERKINS COIE LLP, P.O. BOX 2168, MENLO PARK, CA, 94026, US

(21) Appl. No.: 10/932,204

(22) Filed: Aug. 31, 2004

(51) Int. Cl. G06F 15/173

(52) U.S. Cl. 709/223

(57) ABSTRACT

The present system provides a usage analysis engine that receives and stores data relating to the use of a computer interface. The present invention provides and enacts a plurality of algorithms that manage and store the data. The data received from the computer interface is temporarily stored until a screen is closed on the interface and then the received data is permanently stored. The user is further able to view the statistical data relating to their use of the interface to gain insight on their work habits and further to customize their computer interface based on their use of the available functions.

### CROSS-REFERENCE TO RELATED APPLICATION

None

### TECHNICAL FIELD

The present invention relates to computer interfaces, and more particularly to a system and methods for monitoring, storing and analyzing an operator's use of elements within a computer interface.

### BACKGROUND OF THE INVENTION

As the use of computers to perform a larger variety of tasks increases, the need to operate and interface with computers and different software applications also increases. As a result, both the type and style of computer networks for interconnecting computers and the types and styles of software applications to exchange of information, continues to grow. This growth occurs not only in the number of computer networks, but also in their size, as evidenced by the expanding use of local area networks (LANs), wide area networks (WANs), enterprise-wide networks (which might include several WANs) and, ultimately, world-wide networks, such as the internet.

In order to aid and enhance the computer user's understanding and interaction with these numerous types of computers and programs, various application programs have been developed which display commonly used functions of the applications. Some of these applications may provide a graphical format in which to present information to the user. In other types of applications, the user may be presented with only text information regarding their interface with the computer. Another example of computer application interface is found in Microsoft Word, that has common functions such as “File”, “Edit”, and “View”, that may be activated by selecting the appropriate button.

Therefore the task of interfacing with a computer becomes increasingly difficult and burdensome to the operator as both the complexity and variety of interfaces increases. For computer applications that involve complex processes of any appreciable size, the utility of these graphical interface programs is inversely related to the size of the networks on which they are used. This complexity is due to the fact that the monitor screen becomes increasingly crowded as more icons or functions and the like are added to the display screen interface. Furthermore, these interfaces can increase exponentially, and their illustration can result in such a “busy” appearance on the screen that the information contained therein becomes incomprehensible.

It is often the case that a computer user's level of proficiency would be enhanced if their computer interface was more user friendly. The user commonly does not need to know about or use every possible tool available in a given application. Rather, the user may only be using a small portion of the tools or features available. In such a case, most or some of the information provided by an interface is of little value to the computer user. Standard software applications provide interfaces that generally are not customizable by the computer user. It is desirable therefore, to provide a graphical user interface for a user which permits the operator to customize the displayed information in a manner which limits it to that which is particularly useful, and yet still provides the power and flexibility desired.

In addition to allowing interface customization, it would also be desirable for the user to be aware of statistics regarding what features and functions they use (and do not use) on their interface. Accumulating and analyzing this information would allow the user to intelligently customize their personal interface, and further provide insight as to their own personal working style.

### SUMMARY OF THE INVENTION

An embodiment of the present invention provides a system and method for storing a variety of data relating to the use of a computer interface. The stored data may include statistics relating to the use of specific events, programs, functions, and keystokes. The database is connected to a kernel to receive and store data for a plurality of network users. Other embodiments of the present invention provide a usage analysis engine that employs algorithms for enacting the data storing processes. The exemplary algorithms contain both the features of reading and writing to the database. In one exemplary storing algorithm, the storing process is enacted when the user closes a screen on the interface.

Another embodiment of the present invention provides a computer system to enact the algorithms used in the usage analysis engine. The network computer system includes a kernel, a database log, the usage analysis engine, a processor, and a plurality of user interfaces.

In another embodiment of the present invention, the usage analysis engine algorithms and processes are contained in programming code segments that enable the present invention to be used in the computer environment as described herein.

It will be appreciated that the present invention is described below using specific examples that are not intended to limit the invention. The systems and methodology may be applied to a broad range of other computer applications. Therefore these and other advantages of the present invention will become apparent to those skilled in the art upon a reading of the following detailed description and a study of the drawing figures.

### BRIEF DESCRIPTION OF THE DRAWINGS

FIG. 1 is a block diagram of the usage analysis system of the present invention;

FIG. 2 is a screen shot illustrating personal data displayed by an embodiment of the present invention;

FIG. 3 is a screen shot illustrating function codes employed in an embodiment of the present invention;

FIG. 4 is a flow diagram illustrating a data storing process of the usage analysis engine of one embodiment of the present invention;

FIG. 5 is an example of statistics obtained by the usage analysis engine of one embodiment of the present invention;

FIG. 6 is an example of statistics obtained by the usage analysis engine of one embodiment of the present invention;

FIG. 7 is an example of statistics obtained by the usage analysis engine of one embodiment of the present invention;

FIG. 8 is a flow diagram illustrating a data storage process of one embodiment of the present invention;

FIG. 9 is a flow diagram illustrating a data retrieving process of one embodiment of the present invention; and

FIG. 10 is a schematic diagram of the usage analysis engine of another embodiment of the present invention.

### DETAILED DESCRIPTION OF THE PREFERRED EMBODIMENT(S)

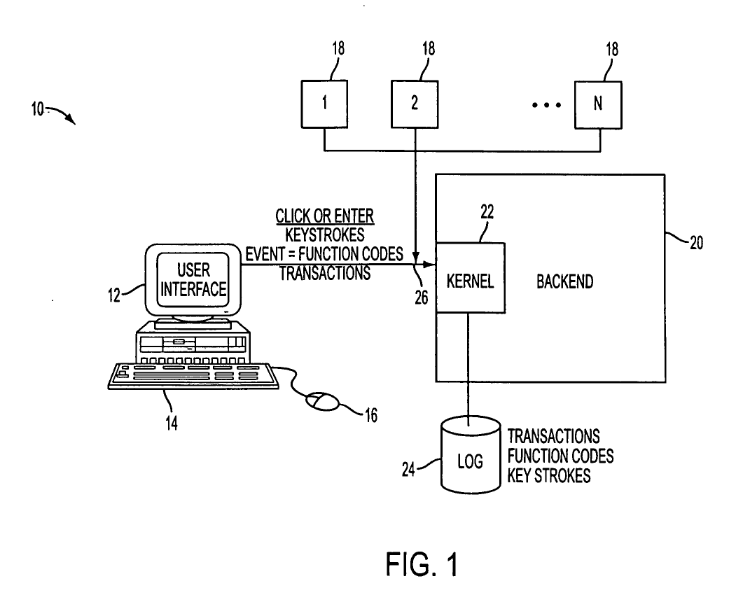

In one embodiment, the present system provides a usage analysis engine that monitors and stores data relating to the use of elements and functions within a computer interface. The usage analysis engine preferably uses a plurality of algorithms to store data and access data from a database. The stored data and statistics of computer use may then be analyzed. Various exemplary embodiments of the present system and methods are described below with reference to FIGS. 1-10.

FIG. 1 is a schematic diagram of an exemplary network computer system 10 of the present invention. A computer user interacts with the computer system 10 through an interface as displayed on monitor 12 by inputting data through a keyboard 14 and mouse 16. A plurality of computer interfaces 18, each containing elements 12-16 are connected to the system as shown. This allows numerous computer users to interact with the system 10. The backend of the system 20 is connected to all the computer interfaces 18 through a bus connection 26. Contained in the backend 20 is a kernel 22 wherein usage data is temporarily stored. A log 24 stores data provided by the kernel 22. The log 24 permanently stores transactions, function codes and keystokes, as transmitted through the bus 26 from each computer interface 18. The backend 20 and kernel 22 contain the programs necessary to run the network 10 that includes the specific screens and interfaces provided to the user through monitor 12. The backend 20 and kernel 22 further contain program segments that contain the exemplary algorithms enacted by the usage analysis engine as will be subsequently described.

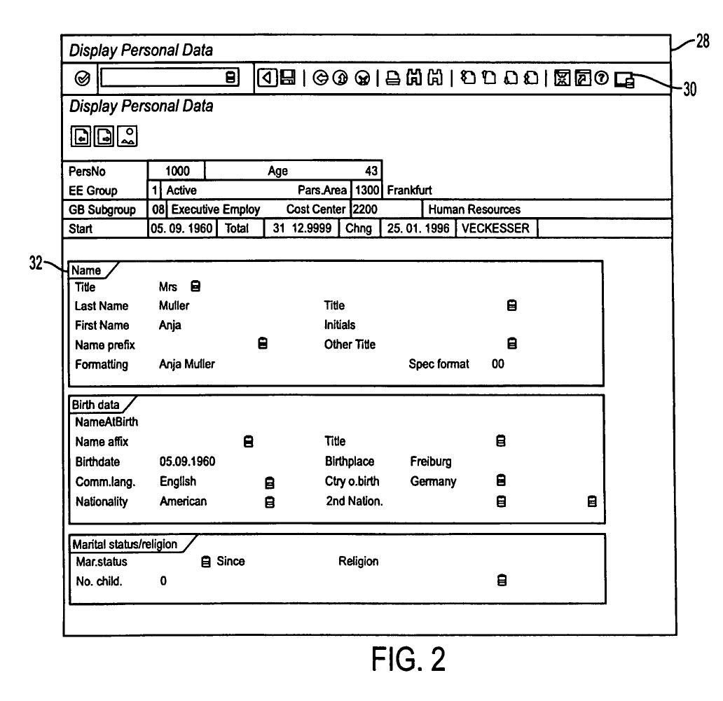

FIG. 2 is a screen shot 28 of a user interface provided by an exemplary embodiment of the present invention. By “screen shot” it is meant that an image displayed on a screen of a computer or the like at a particular point in time is reproduced as a figure. In this example a Human Resources or “HR” application interface is shown that “Displays Personal Data”. The interface screen 28 would be provided by the network to the user's display. The user interface screen 28 would be dependent upon the type of application running, for example an employee in the accounting department may have a different type of interface screen that has features relating to accounting duties. The user interface includes a tool bar of features 30 that are commonly employed in a HR administrator environment. These features include for example, the functions of “Save”, “Previous”, “Next”, “Documents”, “Documentation”, “E-Mail”, “Phone Call”, and “Print”. The interface screen 28 further contains a main work screen 32, which in this example provides a window for the user to enter and view personal data for an employee. The name of the employee in this example is “Anja Muller”. The user interacts with the interface screen 28 through the use of the keyboard 14 and mouse 16 as shown in FIG. 1.

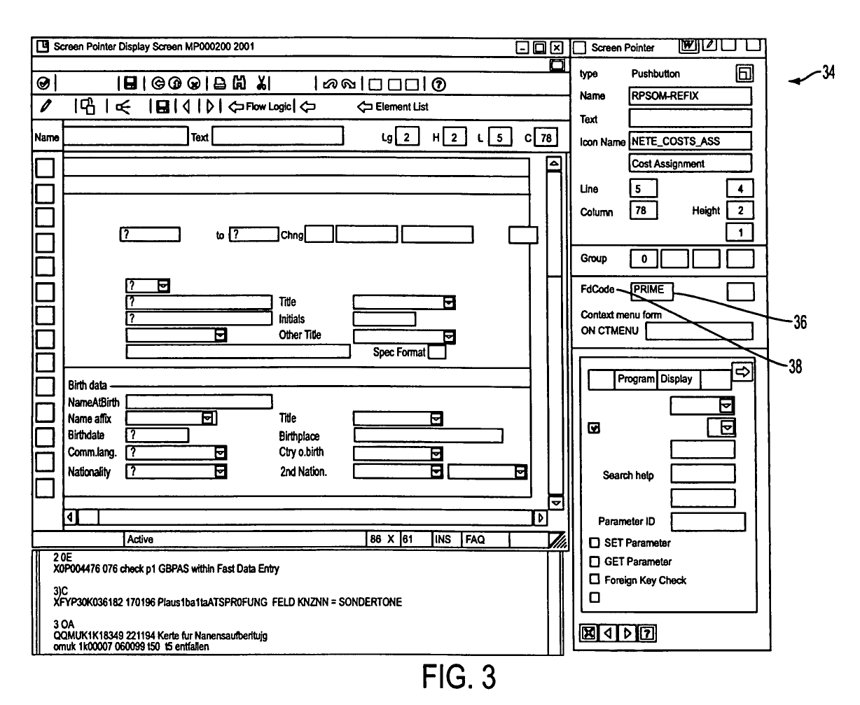

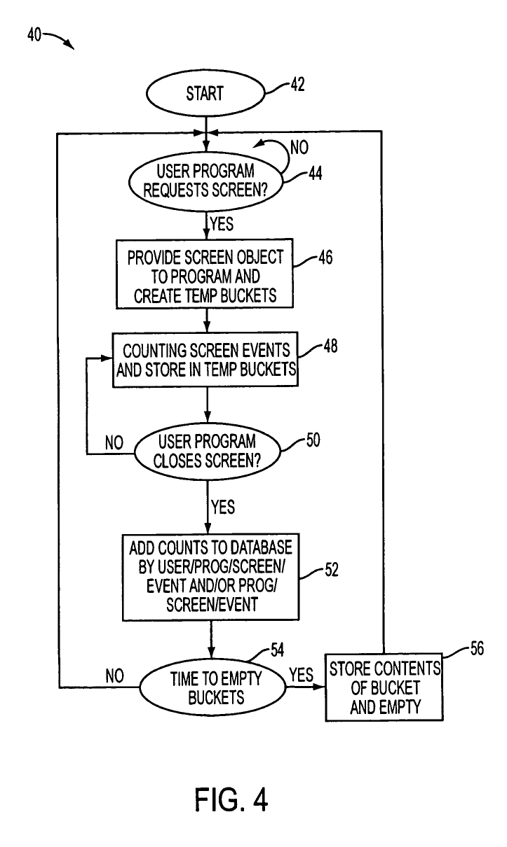

FIG. 3 is a screen shot 34 of a user interface provided by an exemplary embodiment of the present invention. In screen shot 34, the “PRIM” function 36 is highlighted. The “PRIM” function 36 is found in the toolbar 30 as shown in FIG. 2. When the user enacts the “PRIM” function, a function code 38 is transmitted from the user interface to the kernel and backend of the computer network. Once detected by the usage analysis engine, the “PRIM” function would enact a data storage algorithm as shown in FIG. 4.

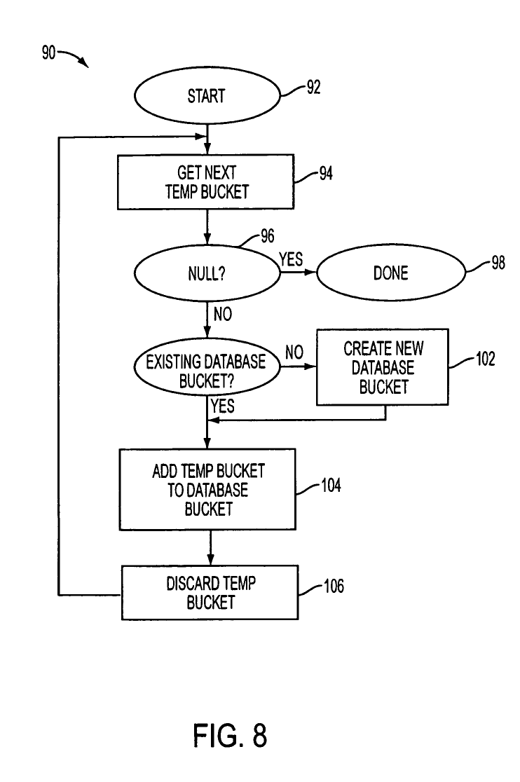

FIG. 4 is a flow diagram illustrating an exemplary process 40 enacted by the usage analysis engine to receive and store data from the computer interface. The exemplary process starts in step 42 and then in step 44 a “user program request screen” condition is determined. This condition i.e. a new screen is provided on the interface, is instigated by the user entering a function code such as “PRIM”, or for example saving and closing a document, or any other event that requires a different screen to be displayed to the user. If the answer is “No”, the process returns to this step (42) and awaits a screen request. If the answer is “Yes” to step 42, step 46 is enacted and the usage engine will provide screen object to program and create temp buckets. These temp buckets contained in the kernel will temporarily store the received data from the interface. In step 48 the engine counts the screen events and stores them in the temporary buckets created in step 46. In step 50 it is determined if the user or the program closes the screen on the interface. If the answer in step 50 is “No”, the process keeps counting and storing the screen events in step 48. If the answer is “Yes” in step 50, step 52 will add the screen counts to the database by user/program/screen/event and/or program/screen/event. The algorithm and processes involved in step 52 are shown in greater detail in FIG. 8. In step 54 it is determined if it is time to empty the temporary buckets. If not, the process returns to step 44 without action. If the answer is “Yes” in step 54, the contents of the buckets are stored and then emptied in step 56.

This continuous process 40 allows usage data to be constantly monitored, received and stored by modifying the kernel within the usage analysis system. As described above, the data is temporarily stored in step 48 and when the screen is closed, the data is then permanently stored in the log in step 52. Once stored, the data may be examined by the user in order to intelligently personalize their computer interface and perhaps change or streamline their working habits based on their use of functions and transactions stored by the usage engine. Processes and methods of the usage analysis engine are also contained in application Ser. No. 10/999,999, attorney docket number 42841-8015.US01, filed on Aug. 15, 2004, the complete contents of which are herein incorporated by reference.

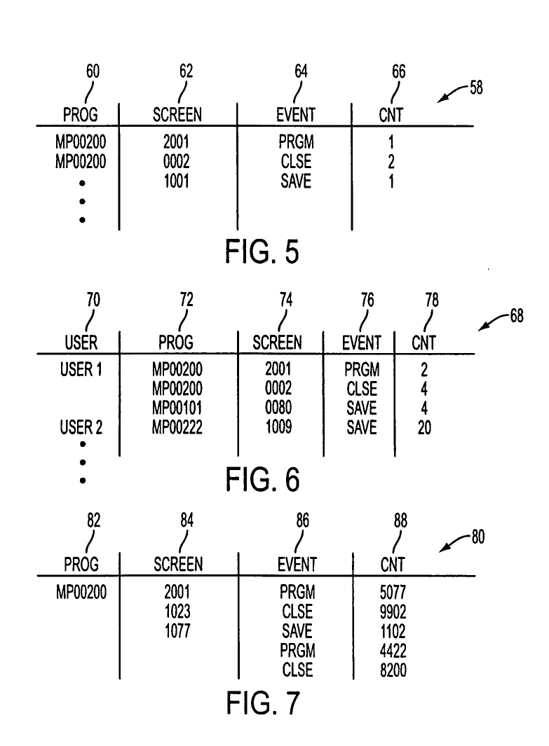

FIG. 5 is an exemplary table of statistics 58 received and stored by an embodiment of the usage analysis engine. In this example, the table of data 58 is divided into 4 columns, Program 60, Screen 62, Event 64 and Count 66. This statistical information 58 is permanently stored in the system data log. Each program 60 enacted by the network system is identified with a number as is each screen 62 contained in each program. In this manner, the data regarding the use of the interface may be stored in the log. Events 64 such as “closing”, “saving”, and calling a new “program” would prompt a permanent storage of the count data 66. The count data 66 consists of the number of operator keystrokes on a given screen for example.

FIG. 6 is an exemplary table of statistics 68 received and stored by an embodiment of the usage analysis engine. In this example, the table of data 68 is divided into 5 columns, User 70, Program 72, Screen 74, Event 76 and Count 78. As shown in FIG. 1, the network system is accessed by a plurality of computer users. In this example the data is stored and grouped in the log for each specific user 70. The usage analysis engine determines and differentiates between computer users 70 within the network, and then stores the statistical usage data by Program 72, Screen 74, Event 76 and Count 78. As described above, each program 72 and screen 74 is referenced by a number and stored into the data log. Events 76 such as closing or saving a document prompt the usage engine to save the counted keystroke data 78 that has been stored in temporary buckets up to that point.

FIG. 7 is another exemplary table of statistics 80 received and stored by the usage analysis engine. The table of data 80 is divided and stored in columns, Program 82, Screen 84, Event 86 and Count 88. In this example, program “MP00200” is saved in column 82, wherein screens 2001, 1023 and 1077 have been enacted by the user and stored in column 84. Accordingly, the number of keystokes for each of these respective screens has been stored in column 88, when prompted by the events in column 86. In this manner the received data is grouped and stored.

FIG. 8 is a flow diagram illustrating in greater detail, the exemplary steps 90 enacted in step 52 as shown in FIG. 4, wherein the counted data is stored in memory. This exemplary process starts in step 92 and then proceeds to step 94 where the usage engine gets the next temp bucket to store user data. In step 96 if the next temp bucket is “Null?”, the process ends in step 98. If the next temp bucket is not “Null”, the process continues in step 100 where it is determined if the temp bucket is an already existing database bucket. If the answer is “No” in step 100, a new database bucket is created in step 102. If the answer is “Yes in step 104, the usage engine will add the temp bucket to the database bucket. The temp bucket is then discrded in step 106, and the process returns to step 94. In this manner the temporary buckets for storing usage data are employed by the usage engine and incorporated into the algorithm of FIG. 4.

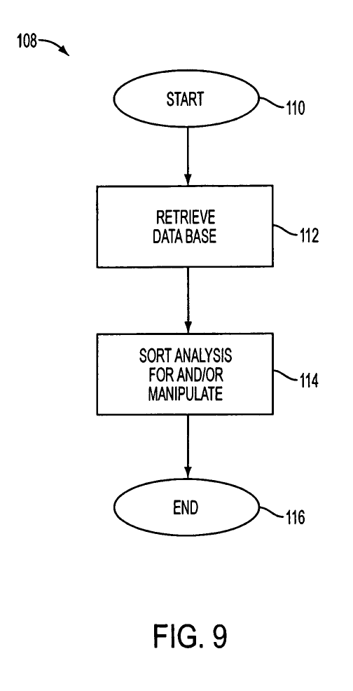

FIG. 9 is a flow diagram illustrating the steps 108 enacted in the exemplary database accessing process. The exemplary process 108 starts in step 110 and then proceeds to step 112 where the database is retrieved and accessed by the usage engine. In step 114 the data is sorted for analysis and manipulation. In order to enact this process the data is displayed to the operator on their personal interface. The data may be used for interface customization purposes or viewed to gain insight regarding working habits. The process then is finished in step 116.

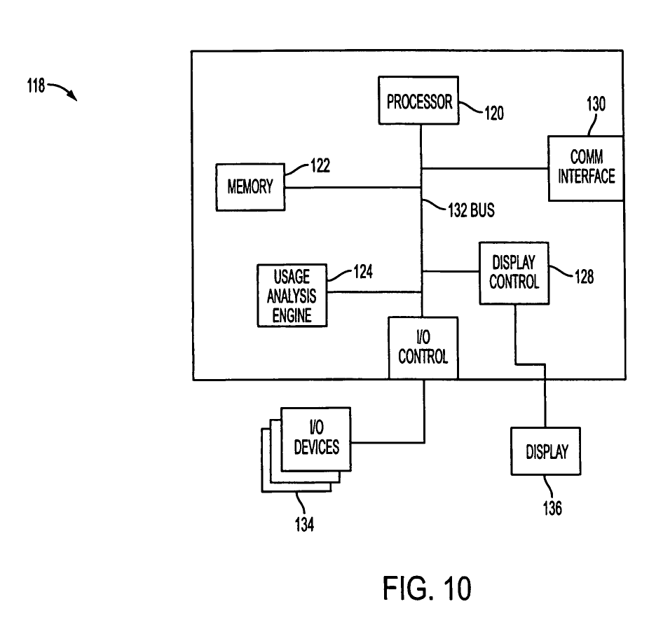

FIG. 10 is a schematic diagram of another embodiment of a computer system 118 that can be used to support the usage analysis engine and the methods for storing data relating to the use of a computer interface as described above. The exemplary system 118 is another embodiment providing the means to perform the desired functions described above such as a means for providing a plurality of computer interface screens to a user interface, a means to receive data from an interface, a means for providing temporary storage for received data relating to the use of the interface screen, a means for detecting the closing of an interface screen, and a means for permanently storing the received data in response to the means for detecting the closing of an interface screen. The computer system 118 may interface to external systems through the modem or network interface 130. It will be appreciated that the modem or network interface 130 can be considered to be part of the computer system 118. This interface 130 can be an analog modem, ISDN modem, cable modem, token ring interface, satellite transmission interface (e.g. “Direct PC”), or other interfaces for coupling a computer system to other computer systems.

The exemplary computer system 118 includes a processor 120, which can be a conventional microprocessor such as an Intel Pentium microprocessor or Motorola Power PC microprocessor. Memory 122 is coupled to the processor 120 by a bus 132. Memory 122 can be dynamic random access memory (DRAM) and can also include static RAM (SRAM). The bus 132 couples the processor 120 to the memory 122, to the usage analysis engine 124, to display controller 128, and to the input/output (I/O) controller 126. The processor 120 and the usage analysis engine 124 work together to enable and enact the methods of the present invention. The algorithms and processes of the usage engine would be contained in computer programmed code segments as is conventional.

The display controller 128 controls the display device 136 from instructions received from the processor 120 and the memory 122 to provide the user interfaces and store the usage data. The input/output devices 134 can include a keyboard, disk drives, printers, a scanner, and other input and output devices, including a mouse or other pointing device. The display controller 128 and the I/O controller 126 can be implemented with conventional well-known technology to provide the customized user interface.

The non-volatile storage of data into memory 122 is often a magnetic hard disk, an optical disk, or another form of storage for large amounts of data. Some of this usage data is often written, by a direct memory access process, into memory 122 during execution of software in the computer system 118. One of skill in the art will immediately recognize that the terms “machine-readable medium” or “computer-readable medium” includes any type of storage device that is accessible by the processor 120 and also encompasses a carrier wave that encodes a data signal.

The exemplary computer system 118 is one example of many possible computer systems that have different architectures. For example, personal computers based on an Intel microprocessor often have multiple buses, one of which can be an input/output (I/O) bus for the peripherals and one that directly connects the processor 120 and the memory 122 (often referred to as a memory bus). The buses are connected together through bridge components that perform any necessary translation due to differing bus protocols.

Network computers do not usually include a hard disk or other mass storage, and the executable programs are loaded from a network connection into the memory 122 for execution by the processor 120. A Web TV system, which is known in the art, is also considered to be a computer system according to this embodiment, but it may lack some of the features shown in FIG. 10, such as certain input or output devices. A typical computer system will usually include at least a processor, memory, and a bus coupling the memory to the processor.

In addition to the algorithms of the present invention, the exemplary computer system 118 is controlled by operating system software that includes a file management system, such as a disk operating system, which is part of the operating system software. One example of an operating system software with its associated file management system software is the family of operating systems known as Windows® from Microsoft Corporation of Redmond, Wash., and their associated file management systems. Another example of an operating system software with its associated file management system software is the LINUX operating system and its associated file management system. The file management system is typically stored in the memory 122 and causes the processor 120 to execute the various acts required by the operating system to input and output data and to store data in memory, including storing files on the memory 122.

Some portions of the detailed description relating to the usage analysis engine 124 have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Some embodiments also relate to the apparatus for performing the operations herein. This apparatus may be specially constructed for the required purposes, or it may comprise a general purpose computer selectively activated or reconfigured by a computer program stored in the computer. Such a computer program may be stored (embodied) in a computer (machine) readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein relating to the usage analysis engine are not inherently related to any particular computer or other apparatus. Various general purpose systems may be used with programs in accordance with the teachings herein, or it may prove convenient to construct more specialized apparatus to perform the required method steps. In addition, the present invention is not described with reference to any particular programming language, and various embodiments may thus be implemented using a variety of programming languages.

One skilled in the art will appreciate that although specific embodiments of the usage analysis and data storage system have been described for purposes of illustration, various modifications can be made without deviating from the spirit and scope of the present invention. For example, embodiments of the present invention may be applied to many different types of databases, systems and application programs. Accordingly, the invention is described by the appended claims.

What is claimed is:

1. A method for receiving and storing data relating to the use of a computer interface comprising:
receiving data from a computer interface;
temporarily storing the data received from the computer interface; and
permanently storing the data received from the computer interface when a predetermined condition occurs.

2. A method for receiving and storing data relating to the use of a computer interface as recited in claim 1 wherein the data received from a computer interface contains function codes.

3. A method for receiving and storing data relating to the use of a computer interface as recited in claim 2 wherein the data received from a computer interface contains keystrokes.

4. A method for receiving and storing data relating to the use of a computer interface as recited in claim 3 wherein the data received from a computer interface contains program events.

5. A method for receiving and storing data relating to the use of a computer interface as recited in claim 4 wherein the predetermined condition is a user closes a screen on the interface.

6. A method for receiving and storing data relating to the use of a computer interface as recited in claim 5 wherein the step of temporarily storing the data received from the computer interface includes creating temporary database buckets to store the received data.

7. A method for receiving and storing data relating to the use of a computer interface as recited in claim 6 wherein the step of permanently storing the data received from the computer interface includes storing data for a plurality of computer users.

8. A method for monitoring and storing data relating to the use of a computer interface as recited in claim 7 wherein the plurality of computer users are connected to a network kernel.

9. A method for monitoring and storing data relating to the use of a computer interface as recited in claim 7 wherein a user may view and analyze their stored data relating to use of their computer interface.

10. A method for monitoring and storing data relating to the use of a computer interface as recited in claim 9 wherein the step of temporarily storing the received data is enacted after the step of permanently storing the received data.

11. A computer interface usage analysis engine comprising:
means for receiving data from a computer interface;
means for temporarily storing the received data from the computer interface; and
means for permanently storing the received data from the computer interface.

12. A computer interface usage analysis engine as recited in claim 11 wherein the means for permanently storing the received data further comprising:
means for determining if the received data is to be temporarily or permanently stored.

13. A computer interface usage analysis engine as recited in claim 12 wherein said means for determining if the received data is to be temporarily or permanently stored enables one of said means for temporarily storing the received data or said means for permanently storing the received data.

14. A computer interface usage analysis engine as recited in claim 13 wherein said means for determining if the received data is to be temporarily or permanently stored is enabled when a screen is closed on the user interface.

15. A computer interface usage analysis engine as recited in claim 14 wherein said received data from the computer interface includes keystrokes and function codes.

16. A computer interface usage analysis engine as recited in claim 15 wherein the received data may be analyzed by the user.

17. A computer interface usage analysis engine as recited in claim 13 further comprising a display means for providing a user interface.

18. A computer interface usage analysis engine comprising:
means for providing a plurality of computer interface screens to a user interface;
means for providing temporary storage for received data relating to the use of an interface screen;
means for detecting the closing of an interface screen; and
means for permanently storing the received data in response to the means for detecting the closing of an interface screen.

19. A computer interface usage analysis engine as recited in claim 18 wherein said received data contains keystrokes and function codes.

20. A computer interface usage analysis engine as recited in claim 19 wherein the received data is stored and grouped by program, screen, and event.
